(19) United States
(12) Patent Application Publication
(10) Pub. No.: US 2010/0275519 A1
(43) Pub. Date: Nov. 4, 2010

(54) Plasterboard panel for access to a compartment

(76) Inventor: Roberto Celli, Rimini (IT)

Correspondence Address: ABELMAN, FRAYNE & SCHWAB, 666 THIRD AVENUE, 10TH FLOOR, NEW YORK, NY, 10017, US

(21) Appl. No.: 12/800,631

(22) Filed: May 18, 2010

Related U.S. Application Data
(63) Continuation-in-part of application No. 11/577,138, filed on Apr. 12, 2007.

(30) Foreign Application Priority Data
Oct. 13, 2004 (IT) RN2004A000048

(51) Int. Cl. E06B 3/36

(52) U.S. Cl. 49/398

(57) ABSTRACT

In a plasterboard panel a first plasterboard sheet has an opening delimited by a first outer zone of the first sheet; a second plasterboard sheet forms a door which can be connected to the opening in the first sheet, the second plasterboard sheet comprising a second outer zone delimiting the door. The panel also comprises holding means for stably connecting the door to the opening. The first outer zone is tapered transversally to the plane in which the panel lies and narrows from a first flat surface of the first sheet to a second flat surface of the first sheet opposite the first flat surface. The second outer zone is tapered transversally to the plane in which the panel lies and narrows from a first flat surface of the second sheet to a second flat surface of the second sheet opposite the first flat surface.

### CROSS REFERENCE TO RELATED APPLICATIONS

This application is a continuation-in-part of prior application Ser. No. 11/577,138, filed Apr. 12, 2007, which is a U.S. national phase entry of PCT/IB05/03197, filed Oct. 5, 2005, which claims the benefit of Italian priority application No. RN2004A000048, filed Oct. 13, 2004, all of which are incorporated herein by reference.

### TECHNICAL FIELD

The present invention relates to a plasterboard panel for access to a compartment.

In particular, according to a first aspect, the present invention is intended for a plasterboard panel for access to a compartment of the type comprising a first plasterboard sheet having a first flat surface and a second flat surface opposite the first. This first plasterboard sheet, having an opening extending between the first and the second flat surfaces, comprises a first outer zone, delimiting the opening, which extends at least partly in the same plane as the first flat surface. The plasterboard panel also comprises a second plasterboard sheet having a first flat surface and a second flat surface opposite the first, forming a door which can be connected to the opening in the first sheet. The second plasterboard sheet comprises a second outer zone delimiting the door. Moreover, the plasterboard panel is equipped with holding means for stably connecting the door to the opening, for a door closed configuration, and for at least partly removing the door from the opening, for a door open configuration.

### BACKGROUND ART

These types of plasterboard panels are normally used to allow access to a compartment by removing or moving the door formed by the second sheet.

In this way, inside the compartment, which may for example be a cavity between two walls, there may be any device, such as an electrical panel, a local vent, and other devices, which requires periodic or impromptu adjustments, repairs or other operations.

Moreover, the access panels in the prior art briefly described open outwards, that is to say, on the side opposite the compartment, making use of the above-mentioned holding means.

If the door in the access panels were to open into the compartment, the space needed for door movement could not be used by the device contained in the compartment.

The prior art includes a plurality of different holding means, to allow door outward opening.

In particular, access panels are known in which the door and the first sheet are joined together by hinges located on external portions of the panel, that is to say, on portions of the panel which, when panel installation is complete, are not facing the compartment.

Because they are made of plasterboard, the prior art panels for access to a compartment allow surface finishing machining which integrates very well with the walls forming the compartment and on which the access panel is installed.

It is quite desirable that, when the door is in the closed configuration, the door lies in the same plane as the sheet having the access opening, without unevenness in the plane formed by the wall on which the access panel is installed.

For this purpose, access panels are known which have stop elements for the door. The stop elements are located on an internal portion of the first sheet, that is to say on the surface of the first sheet directly facing the compartment, so that, when it is in the closed configuration, the door rests against the stop elements, remaining in a predetermined configuration.

The prior art includes a plurality of solutions for joining the edges of the door and the edges of the opening in the first sheet.

From a structural viewpoint, said plurality of solutions may be traced back to a single general solution.

In particular, said general solution involves the closing doors having edges perpendicular to the plane formed by the sheet which forms the door itself. These edges correspond to opening edges perpendicular to the first sheet, that is to say, to the sheet in which the opening is made.

Also known is the use of profiles and counter-profiles, both internal or external, applied to the edges of the opening and/or to the edges of the panel to avoid creating gaps between the door and the opening edge. The shape and configuration of such profiles and counter-profiles forms the above-mentioned plurality of solutions.

The Applicant has found that several aspects of prior art plasterboard panels for access to a compartment.

The prior art plasterboard panels for access to a compartment are subject to damage in the portion with the edges of the door and the edges of the sheet on which the access opening is made, compromising panel functionality.

This disadvantage is due to the fact that the right angle edges of the door and of the opening tend to collide every time the door is closed, particularly after prolonged use of the access panel.

Due to the low tolerances between the door and the opening, needed to prevent the formation of gaps, a small error in the movement for reinserting the door in the opening is enough to cause interference between the edges of the door and of the opening as the door is closed. This movement error becomes inevitable after prolonged use of the door. For example, when the door is hinged to the edges of the opening, since the door is made of plasterboard subjected to a high weight force resting on the hinges forming the axis of rotation, over time a slight misalignment of the axis of rotation between the door and the opening becomes inevitable.

Moreover, in the prior art access panels it is practically impossible to reduce the presence of gaps between the door and the opening to zero without using stop profiles and counter-profiles, since, given the finished thickness of the door and of the sheet on which the opening is made, any relative movement of the door and the opening requires a tolerance between the door dimensions and the opening dimensions in order to operate, for example to be able to guarantee door rotation relative to the opening.

This requirement means that the prior art plasterboard panels for access to a compartment are very complex to make.

### DISCLOSURE OF THE INVENTION

In this context, the main technical need of the present invention is to propose a plasterboard panel for access to a compartment which is free of the above-mentioned disadvantages.

In particular, the aim of the present invention is to provide a plasterboard panel for access to a compartment without gaps between the door and the opening.

Another aim of the present invention is to propose a plasterboard panel for access to a compartment which, even after prolonged used, maintains its functionality unchanged.

The technical need indicated and the aims specified are substantially achieved by a plasterboard panel for access to a compartment comprising the technical features described in one or more of the claims herein.

### BRIEF DESCRIPTION OF THE DRAWINGS

Further features and advantages of the present invention are more apparent in the detailed description below, with reference to a preferred, non-restricting, embodiment of a plasterboard panel for access to a compartment illustrated in the accompanying drawings, in which:

FIG. 1 is a perspective view of a plasterboard panel for access to a compartment according to the present invention in a first operating configuration;

FIG. 2 is a perspective view of the panel illustrated in FIG. 1 in a second operating configuration;

FIG. 3 is a cross-section according to the plane of the panel illustrated FIG. 1;

FIG. 4 is a perspective view of an alternative embodiment of the panel illustrated in FIG. 1;

FIG. 5 is a schematic perspective view of a plasterboard panel for access to a compartment, seen from the inside of the compartment and illustrating an alternative embodiment of the means for holding a door in the closed configuration;

FIG. 6 is a cross-section of the plasterboard panel illustrated in FIG. 5 according to the plane IV-IV in FIG. 5, but in which the door is shown in the open configuration;

FIGS. 7a-7b are schematic perspective views of a plasterboard panel for access to a compartment, seen both from the inside (FIG. 7b) and the outside (FIG. 7a) of the compartment, both in a closed (FIG. 7b) and in an open (FIG. 7a) configuration and illustrating an alternative embodiment of the means for holding a door in the closed configuration; and

FIGS. 8a-8c illustrate a sequence of cross-sectional views of the hinge from FIGS. 7a-7b, being illustrated in a plurality of successive operative configurations.

### DETAILED DESCRIPTION OF THE PREFERRED EMBODIMENTS OF THE INVENTION

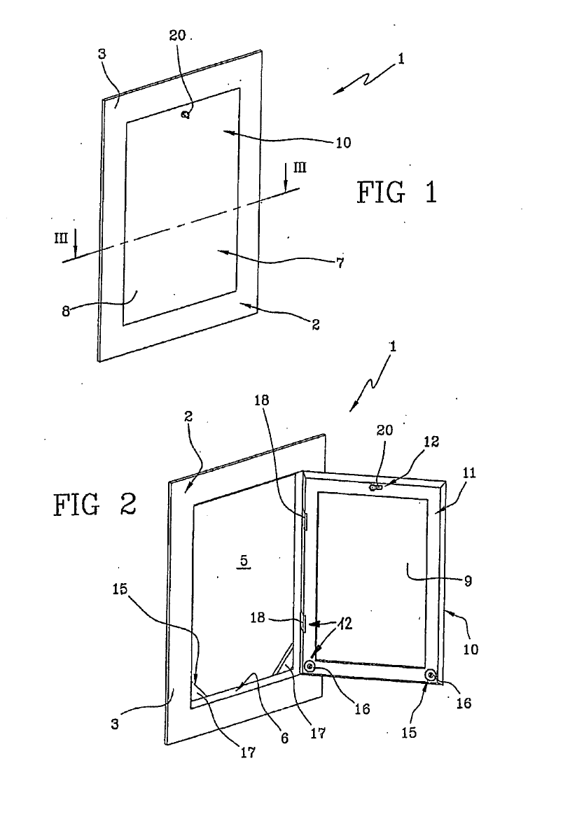

With reference to FIGS. 1 and 2, the numeral 1 denotes a plasterboard panel for access to a compartment.

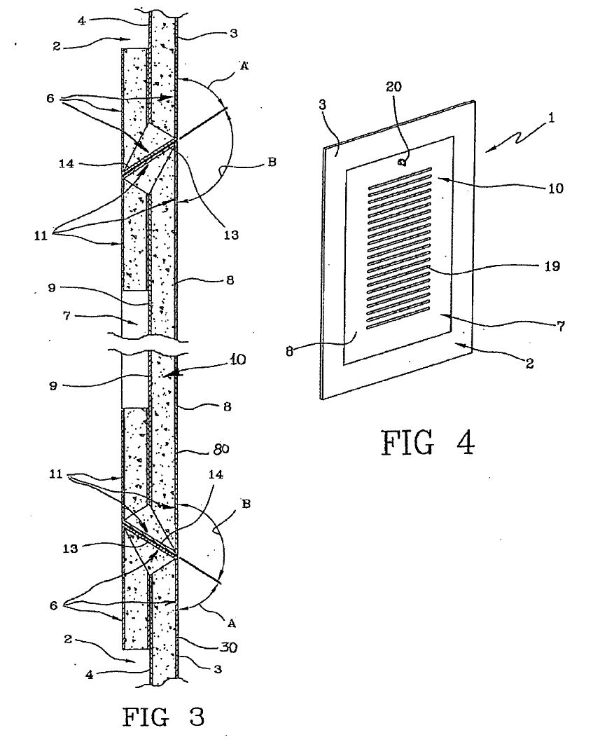

With reference also to FIG. 3, the plasterboard panel 1 comprises a first plasterboard sheet 2 having a first flat surface 3 and a second flat surface 4 opposite the first 3. The first plasterboard sheet 2, having an opening 5 extending between the first and the second flat surfaces 3, 4, comprises an outer zone 6 which delimits the opening 5 and which extends at least partly in the same plane as the first flat surface 3. The panel 1 also comprises a second plasterboard sheet 7 having a first flat surface 8 and a second flat surface 9 opposite the first 8, forming a door 10 which can be connected to the opening 5 in the first sheet 2. The second plasterboard sheet 7 comprises a second outer zone 11 delimiting the door 10.

The panel 1 comprises holding means 12 for stably connecting the door 10 to the opening 5, for a door 10 closed configuration (for example, illustrated in FIG. 1). The holding means 12 also have the function of allowing the door 10 to be at least partly removed from the opening 5, for a door 10 open configuration (for example, illustrated in FIG. 2).

When the door 10 is in the closed configuration, as illustrated in FIG. 1, the first flat surface 3 of the first sheet 2 and the first flat surface 8 of the second plasterboard sheet 7 lie in the same plane.

To pass from the door closed configuration to the door 10 open configuration, the door 10 must be turned or removed relative to the opening 5 from the opposite side to the compartment, that is to say, towards the outside of the cornpartment.

As illustrated in FIG. 3, the outer zone 6 is flared transversally to the plane in which the panel 1 lies and narrows from the first flat surface 3 of the first sheet 2 to the second flat surface 4 of the first sheet 2. At the same time, the second outer zone 11 is flared transversally to the plane in which the panel 1 lies and narrows from the first flat surface 8 to the second flat surface 9 of the second sheet 7.

In particular, the first outer zone 6 comprises first outer edges 13 facing the opening 5, whose inclination relative to the plane in which the panel 1 lies forms the flaring of the first outer zone 6. Similarly, the second outer zone 11 comprises second outer edges 14 extending around the outside of the door 10 and whose inclination relative to the plane in which the panel 1 lies forms the flaring of the second outer zone 11.

Advantageously, a portion of the first flat surface 3 of the first sheet 2 extends without interruption forming at least the first outer edges 13. Similarly, a portion of the first flat surface 8 of the second sheet 7 extends without interruption forming at least the second outer edges 14.

In more detail, the first and second flat surfaces 3, 4 of the first sheet 2, like the first and second flat surfaces 8, 9 of the second sheet 7, are made of board layers 30, 80. Between two respective board layers there is a sheet of gypsum plaster, so that the assembly of board layers and gypsum plaster sheet forms the typical plasterboard structure.

Advantageously, the first outer edges 13 of the opening 5 and the second outer edges 14 of the door 10 are covered with board layers 30, 80, preventing the opening 5 or the door 10 from having gypsum plaster parts in direct contact. Moreover, advantageously, if the board layers 30, 80 extend without interruption respectively from the first flat surface 3 of the first sheet 2 to the first outer edges 13 and from the first flat surface 8 of the second sheet 7 to the second outer edges 14, this provides simply an extension without interruption of the first surface 3 of the first sheet 2 and of the first surface 8 of the second sheet 7 respectively to the first and second outer edges 13, 14.

As illustrated in FIG. 3, the first outer zone 6 comprises an extension of the first plasterboard sheet 2 projecting into the opening 5, which can be suitably folded on the second flat surface 4 of the first sheet 2, in particular in contact with the later, as illustrated in FIG. 3. The presence of the extension of the first sheet 2 forms a first frame in the first outer zone 6 (especially if the extension is folded in contact on the second flat surface 4 of the first sheet 2).

Similarly, the second outer zone 11 comprises an extension of the second plasterboard sheet 7 located on the opposite side to the first flat surface 8 of the second sheet 7. Said extension can be suitably folded on the second flat surface 9 of the second sheet 7, in particular in contact with the latter, as illustrated in FIG. 3. The presence of the extension of the second sheet 7 forms a second frame in the second outer zone 11 (particularly if the extension is folded in contact on the second flat surface 9 of the second sheet 7).

The flaring of the first outer zone 6 is formed by a first portion inclined at a constant angle A between the first flat surface 3 of the first sheet 2 and the first outer edge 13.

The flaring of the second outer zone 11 is formed by a second portion inclined at a constant angle B between the first flat surface 8 of the second sheet 7 (and, therefore, of the door 10) and the second outer edge 14.

The flaring of the first and second outer zones 6, 11 is such that they are shaped to match one another, allowing perfect door 10 closing on the opening 5. In particular, the first and second angles A, B are supplementary to one another, that is to say, the sum of the absolute value of the first angle A and the absolute value of the second angle B is 180°.

In the preferred embodiment, the first angle A has an amplitude of between 30° and 80°, preferably 60°.

Obviously, the dimensions of the door 10 are such that they allow perfect insertion and perfect closing of the opening 5.

To guarantee stable operating connection of the door 10 to the opening 5 and, at the same time, the possibility of the door 10 passing between the open configuration and the closed configuration, as indicated, the panel 1 comprises holding means 12.

In detail, the holding means 12 comprise anchoring means 15 active between the door 10 and the first outer zone 6. Said anchoring means 15, which in the preferred embodiment are magnetic, are designed to anchor the door 10 to the first sheet 2 when the door 10 is in the closed configuration. In the preferred embodiment, the anchoring means 15 comprise at least one magnet 16, preferably two, stably housed in the second outer zone 11 and facing the opening 5. With the door 10 closed, the magnet 16 acts on ferromagnetic strikers 17 fixed to the first outer zone 6 and at least partly projecting into the opening 5.

As is schematically illustrated in FIG. 2, the holding means 12 also comprises at least one hinge 18, preferably of the recessed type, acting between the opening 5 and the door 10. The hinge 18 is designed to guide the door 10 between the open and closed configurations.

The panel 1 also comprises at least one lock 20, acting between the door 10 and the first sheet 2 when the door 10 is in the closed configuration. Advantageously, the lock 20 may be a button lock or a key lock. Advantageously, a key lock prevents unauthorised users from accessing the compartment.

It should be noticed that, depending on requirements, the holding means 12 may comprise both the hinge 18 and the anchoring means 15, or just the hinge 18.

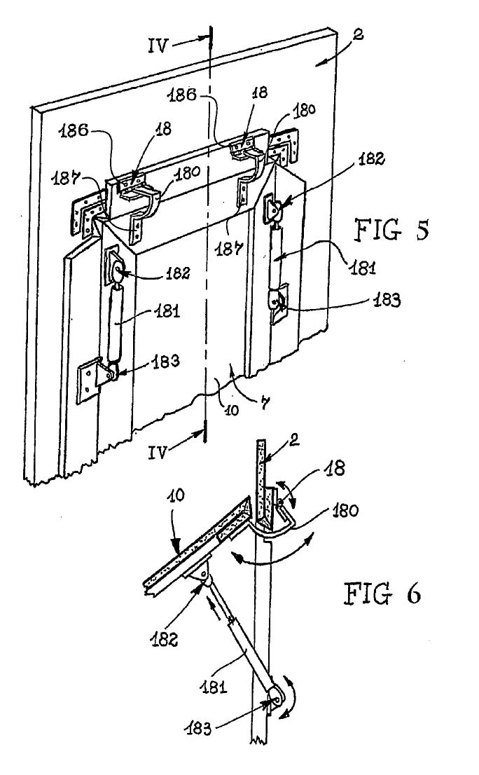

In one embodiment of the invention, in particular illustrated in FIGS. 5 and 6, one or more hinges 18 are fixed to the first sheet 2 (preferably on an upper side of the opening 5, as illustrated in FIGS. 5 and 6) and are connected to the door 10 using shaped brackets 180 which allow the door 10 to open without the door interfering with the first outer edge 13 of the first sheet 2 (see FIG. 3).

In particular, each hinge 18 presents a first coupling element 186 connected to the second flat surface 4 of the first plasterboard sheet 2 and a second coupling element 187 carried in a rigid fashion by a shaped bracket 180 and connected to the second flat surface 9 of the second plasterboard sheet 7. In this way, when the door is closed, neither the hinge 18 nor one of its components is visible when viewed from the side of first flat surfaces 3 and 8. In particular, contrary to the standard hinges shown in FIGS. 1-4, the pivot pin of the hinge 18 is not visible and therefore, when the door 10 is in the respective closed configuration, the hinge 18 of the present embodiment is completely hidden in the rear of the plasterboard panel 1 in order to enhance, or at least safeguard, the aesthetical look of the plasterboard panel itself. In addition it should be noted that the shaped bracket 180 is shaped and arranged such that any portions of the hinge 18 do not contact the first outer edges 13 or the second outer edges 14 (shown in FIG. 3), during opening and closing operations of the door 10.

Telescopic cylinders 181 (for example, containing fluid, in particular gas) have a first end 187 hinged to the door 10 (advantageously on the extension of the second outer zone 11 if present, when the latter is folded on and makes contact with the second flat surface 9 of the second sheet 7) and a second end 183 hinged to the first sheet 2 (at the first outer edge 13 and advantageously on the extension of the first outer edge 6 if present, when the latter is folded on and makes contact with the second flat surface 4 of the first sheet 2). The axes of rotation of the first and second ends 187,183 of the telescopic cylinders 181 are parallel with the axis of rotation formed by the hinges 18. This structure can also allow the door 10 to open by tilting upwards and this open configuration to be stably maintained without effort by the user thanks to the resistance offered by the telescopic cylinders 181 when they are of the fluid type (in particular, containing gas). The arrows in FIG. 6 illustrate the movements of the various parts in the door 10 as it passes between the closed and the open configurations.

In an embodiment illustrated in FIG. 4, the panel 1 has the form of a ventilation grille.

In particular, in this embodiment, the door 10 comprises a plurality of slits 19 extending between the board layers covering the door 10, that is to say between the first and the second flat surfaces 8, 9 of the second sheet 7.

The slits 19, preferably equidistant, allow the passage of an air flow between the compartment closed by the door 10 and the environment outside the compartment. The slits may be closed by a light layer of material permeable to air or by a dust filter.

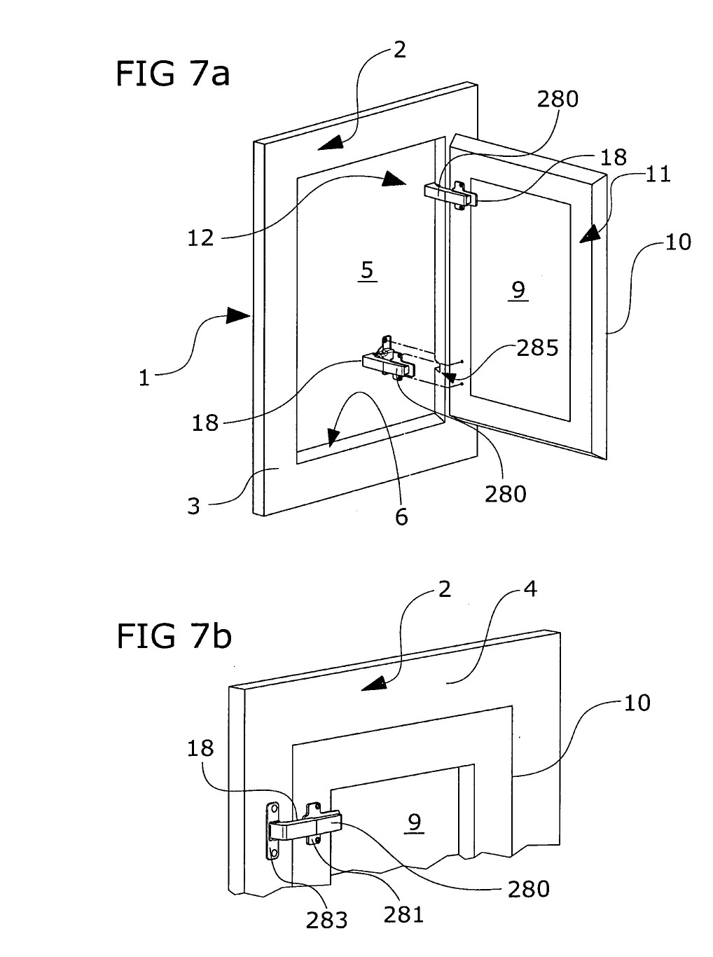

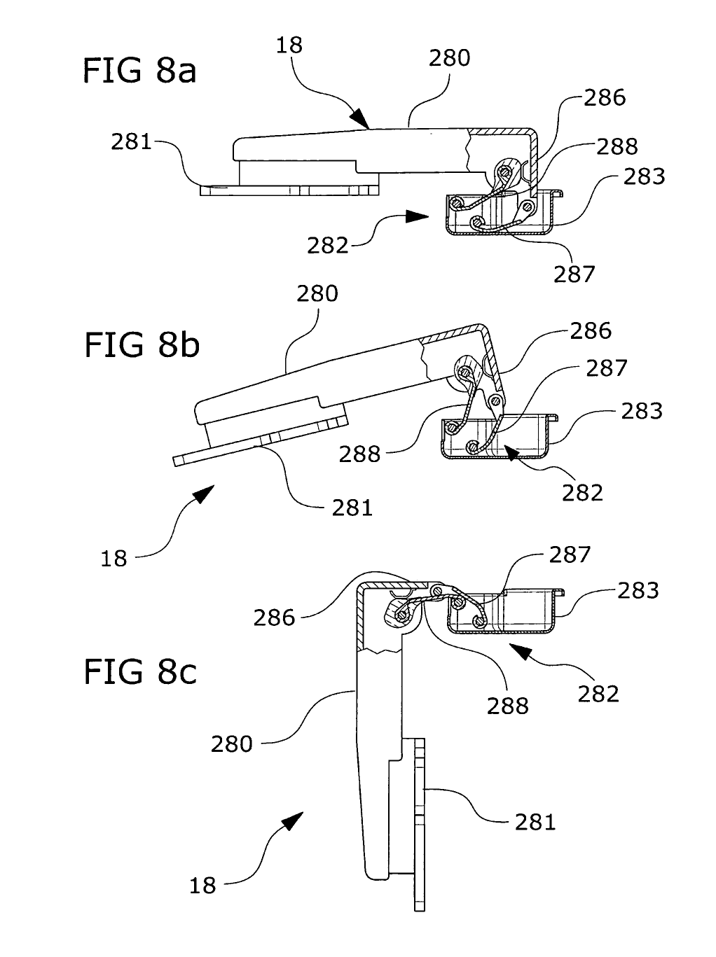

In another embodiment of the invention, illustrated in FIGS. 7a-7b and 8a-8c, the plasterboard panel 1 is equipped with holding means 12 that includes at least one hinge 18 comprising an elongated shaped bracket 280 which is substantially L-shaped and comprises a respective end portion 286 which presents a short longitudinal extension and is interpretable as the “foot” of the “L-shape”. In particular, the shaped bracket 280 is articulated with a first coupling element 283 connected to the second flat surface 4 of first plasterboard sheet 2, and carries in a stable fashion a second coupling element 281 connected to the second flat surface 9 of the second plasterboard sheet 7. More particularly, the shaped bracket 280 and the first coupling element are reciprocally hinged by means of an articulated quadrilateral 282 comprising the first coupling element 283 itself, the end portion 286 of the shaped bracket 280, a first lever 287 which presents the respective ends hinged to the first coupling element 283 and the end portion 286, respectively, and a second lever 288 located between the first lever and the second coupling element 281 and presenting the respective ends hinged to the first coupling element 283 and the end portion 286, respectively.

FIGS. 8a-8c illustrate a sequence of chronological successive operative configurations of the hinge 18 from FIGS. 7a-7b comprised between a closing operative configuration (see FIG. 8a) and an opening operative configuration (see FIG. 8c). In particular, with reference to the FIGS. 8a-8c, it should be noted that the shaped bracket 280 does not perform a simple rotation with respect to the first coupling element 283 to which is hinged, as a standard door hinge or the hinges 18 illustrated in FIGS. 1-6, but, on the contrary, the shaped bracket 280 performs, during opening and closing operations of door 10, a movement which can be described and interpreted as the combination of two rotations about two distinct given axes of rotations. This movement given by the combination of two distinct rotations can be also described and interpreted as a roto-translational movement of the shaped bracket 280 with respect to the first coupling element 283. In any case, the trajectory of this movement and the configuration of the two given axes of rotations are predetermined, during the design phase, by setting the configuration of the articulated quadrilateral 282.

More particularly, with reference to FIGS. 8a-8c, it should be noted that first lever 287 and second lever 288 are preferably bent and present respective cavities oriented toward the second coupling element 281 when the door 10 is in a respective open configuration (see FIG. 8c). More particularly, second lever 288 is substantially C-shaped in such a way that, when the door 10 is in the respective open configuration, the first lever 287 and the second lever 288 enter in mutual contact in order to minimize the bulk of the articulated quadrilateral 282 and such that the second lever 288 does not project outside the shaped bracket 280. Also in this embodiment, as in the embodiment illustrated in FIGS. 5-6, the hinge 18 is connected only to the second flat surface 4 and the second flat surface 9, which are the rear surfaces of the first and second plasterboard sheets 2 and 7, respectively, in such a way to be completely hidden inside the respective compartment, when the door 10 is in the respective closed configuration (see FIG. 8a). In particular, as shown in FIG. 7a, it should be opportune to make in the first outer edges 13 of the first outer zone 6 of the first plasterboard sheet 2 a hollow seat 285 for each hinge 18, wherein the hollow seat 285 is shaped to house a portion of the shaped bracket 280 in order to facilitate the opening/closing of the door 10.

The present invention achieves the preset aims.

The first and second tapered frames create a connection between the door and the opening in the first plasterboard sheet which is free of gaps.

Moreover, operation of the door remains unchanged even after prolonged use, since, even after a minimum movement of the hinge axis of rotation; the connection between the door and the opening is accomplished without interference between the two parts.

The tapering of the frames allows progressive engagement between the door and the opening.

The above disclosure is intended to be illustrative and not exhaustive. This description will suggest many modifications, variations, and alternatives may be made by ordinary skill in this art without departing from the scope of the invention. Those familiar with the art may recognize other equivalents to the specific embodiments described herein. Accordingly, the scope of the invention is not limited to the foregoing specification.

I claim:

1. A plasterboard panel for access to a compartment comprising:
a first plasterboard sheet having a first flat surface and a second flat surface opposite the first flat surface; the first plasterboard sheet having an opening extending between the first flat surface and the second flat surface; the first plasterboard sheet also comprising a first outer zone delimiting the opening, extending at least partly in the same plane as the first flat surface, wherein the first outer zone is tapered transversally to the plane in which the panel lies and narrows from the first flat surface to the second flat surface of the first sheet;
a second plasterboard sheet having a first flat surface and a second flat surface opposite the first flat surface, forming a door which can be connected to the opening in the first sheet; the second plasterboard sheet comprising a second outer zone delimiting the door, wherein the second outer zone is tapered transversally to the plane in which the panel lies and narrows from the first flat surface to the second flat surface of the second sheet;
holding means for stably connecting the door to the opening, for a door closed configuration, and for at least partly removing the door from the opening, for a door open configuration;
the door closed configuration forming a single plane between the first flat surface of the first plasterboard sheet and the first flat surface of the second plasterboard sheet;
wherein the holding means includes at least one hinge fixed to the second flat surface of the first sheet at the opening to allow the door to open without interfering with the first outer edges of the first outer zone;
the at least one hinge comprising:
a first coupling element connected to the second flat surface of the first plasterboard sheet;
an elongated shaped bracket hinged to the first coupling element; and
a second coupling element carried by the elongated shaped bracket and connected to the second flat surface of the second plasterboard sheet,
such that any hinge is not visible from the side of the first flat surface when the door is in the respective closed configuration.

2. The panel according to claim 1, wherein the at least one shaped bracket is hinged to the respective first coupling element in such a way to be suitable, in use, to perform only given roto-translational movements.

3. The panel according to claim 1, wherein the at least one shaped bracket is hinged to the respective first coupling element by way of an articulated quadrilateral.

4. The panel according to claim 3, wherein the at least one shaped bracket is arranged to perform, in use, a movement relative to the respective first coupling element which is a combination of two rotations around two respective distinct given axes of rotation.

5. The panel according to claim 3, wherein the articulated quadrilateral comprises a first coupling element, first and second levers each hinged to the first coupling element and to the shaped bracket, and an end portion of the shaped bracket.

6. The panel according to claim 5, wherein the second lever is a C-shaped lever presenting a respective cavity that is oriented toward the second coupling element when the door is in a respective open configuration.

7. The panel according to claim 1, wherein the holding means further comprises:
at least one telescopic cylinder having a first end hinged to the door and a second end hinged to the first sheet;
the axes of rotation of the first and second ends of the telescopic cylinder being parallel with the axis of rotation formed by the at least one hinge.

8. The panel according to claim 1, wherein the first outer zone comprises first outer edges facing the opening of the first sheet and the second outer zone comprises second outer edges around the outside of the door; the first outer edges 13 of the first plasterboard sheet 2 presents a hollow seat for each hinge in order to house a respective shaped bracket when the door is in a respective open configuration.

9. The panel according to claim 1, wherein the first outer zone comprises first outer edges facing the opening of the first sheet and the second outer zone comprises second outer edges around the outside of the door; the tapering of the first outer zone being formed by a portion inclined at a first constant angle formed between the first flat surface of the first sheet and the first edge; the tapering of the second outer zone being formed by a portion inclined at a second constant angle formed between the first flat surface of the door and the second edge.

10. The panel according to claim 9, wherein the first angle and the second angle are supplementary angles.

11. The panel according to claim 9, wherein a portion of the first flat surface of the first sheet extends without interruption forming at least the first outer edges and wherein a portion of the first flat surface of the second sheet extends without interruption forming at least the second outer edges.

12. The panel according to claim 1, wherein the first outer zone is formed by an extension of the first plasterboard sheet projecting in the opening to form a first frame.

13. The panel according to claim 12, wherein the extension of the first sheet is folded on the second flat surface of the first sheet.

14. The panel according to claim 1, wherein the second outer zone is formed by an extension of the second plasterboard sheet to form a second frame.

15. The panel according to claim 14, wherein the extension of the second sheet is folded on the second flat surface of the second sheet.

16. The panel according to claim 15, wherein the extension of the second sheet is in contact with the second flat surface of the second sheet.
